(19) United States
(12) Patent Application Publication
(10) Pub. No.: US 2012/0248153 A1
(43) Pub. Date: Oct. 4, 2012

(54) Reversal-Type Liquid Measuring Device and Bottle Assembly Having the Same

(76) Inventor: Shi Peng, Shenzhen (CN)

(21) Appl. No.: 13/515,814

(22) PCT Filed: Jun. 29, 2010
(86) PCT No.: PCT/CN10/74728

§ 371 Date: Jun. 14, 2012

(30) Foreign Application Priority Data
Jan. 22, 2010 (CN) 201010109894.X

(51) Int. Cl. G01F 11/26

(52) U.S. Cl. 222/454

(57) ABSTRACT

An overturning device for measuring and dispensing fluid and a bottle arrangement with the same, the overturning device includes a measuring bucket for using with a bottle body. The measuring bucket has a backflow channel, a first compartment, and a second compartment having an inlet opening, and a backflow opening. The first compartment is communicated with the inlet opening, wherein the backflow opening is communicated with the backflow channel, wherein the measuring bucket has a first state in which the fluid in the first compartment is capable of flowing into the second compartment, and a second state in which the fluid in the first compartment is not capable of flowing into the second compartment. The surplus fluid in the second compartment will flow back into the bottle body so that problem of accuracy and practicability of overturning device for measuring and dispensing fluid is solved.

### BACKGROUND OF THE PRESENT INVENTION

1. Field of Invention

The present invention relates to an overturning device for measuring and dispensing fluid and a bottle arrangement with the overturning device.

2. Description of Related Arts

An overturning device for measuring and dispensing fluid achieves measure, storage, and discharge of fluid by one or more times of overturning of the bottle body. According to a great many of experiments, we have found that this kind of measuring and dispensing technology has the following disadvantages. Although an overturning device for measuring and dispensing fluid in the prior art is provided with a measure chamber, a calibration structure is not found in the measure chamber (or temporary storing chamber). Since the amount of the fluid stored in the bottle body is varied, the speed and angle for a user to overturn the device are also varied, so that a volume of the fluid in each measuring and dispensing step is hard to maintain a same volume. As a result, the conventional overturning device for measuring and dispensing fluid is lack of accuracy and practicability.

### SUMMARY OF THE PRESENT INVENTION

The present invention is concerned on a technical solution that is to provide an overturning device for measuring and dispensing fluid accurately and a bottle arrangement with the overturning device by introducing a backflow channel (calibration channel) into the measure chamber (or temporary storing chamber).

Additional advantages and features of the invention will become apparent from the description which follows, and may be realized by means of the instrumentalities and combinations particular point out in the appended claims.

According to the present invention, the foregoing and other objects and advantages are attained by an overturning device for measuring and dispensing fluid comprising a measuring bucket for using with a bottle body, wherein the measuring bucket has a backflow channel, a first compartment having a first compartment base, and a second compartment having a second compartment base, wherein the second compartment has an inlet opening for inlet of the fluid, and a backflow opening for backflow of the fluid, wherein the first compartment is communicated with the inlet opening, wherein the backflow opening is communicated with the backflow channel, wherein the measuring bucket has a first state in which the fluid in the first compartment is capable of flowing into the second compartment under the influence of gravity, and a second state in which the fluid in the first compartment is not capable of flowing into the second compartment, wherein in the first state, the fluid overflowing from the backflow opening of the second compartment flows into the backflow channel. A position of the backflow opening may not be higher than a position of the inlet opening.

Preferably, the first compartment has a guiding channel guiding the fluid in the first compartment to flow into the second compartment, wherein the guiding channel is inclinedly arranged to define a high location at a relatively higher position and a low location at a relatively lower position, wherein the inlet opening is provided at the low location. The guiding channel can be embodied as a slanted surface.

Preferably, the measuring bucket further has a discharge channel for communicating the bottle body to the first compartment, and an inlet channel provided above the second compartment and is communicated with the second compartment.

Preferably, the inlet channel and the backflow channel are respectively provided at two sides of the second compartment. The backflow channel is preferred to be provided circumferentially at a side portion of the measuring bucket. When the measuring bucket is in the second state, the backflow channel can be provided above the fluid in the bottle body so as to prevent the fluid in the bottle body from flowing into the second compartment.

Preferably, the measuring bucket comprises a first measuring bucket and a second measuring bucket which are integrated with each other, wherein the inlet channel has a first inlet channel and a second inlet channel which are sealedly open butt joined with each other, wherein the first compartment has a first lower compartment and a first upper compartment which are sealedly open butt joined with each other, wherein the first lower compartment, the first inlet channel, the backflow channel, and the second compartment are provided in the first measuring bucket, wherein the first upper compartment, the first inlet channel, and the discharge channel are provided in the second measuring bucket, wherein the discharge channel is sealedly open butt joined with the second compartment.

Preferably, the backflow channel is provided with a one-way valve for preventing the fluid in the bottle body from flowing into the second compartment in the first state.

Preferably, the backflow channel has a first backflow chamber having a base wall and an opening communicated with the first compartment. The first back flow chamber with a base wall is provided for temporarily storing the fluid overflowing from the backflow opening of the second compartment.

Preferably, the overturning device for measuring and dispensing fluid further comprises a first top cap capped on the measuring bucket, wherein the first top cap has a sealing portion for covering the inlet channel and the first compartment, and a discharge opening communicated with the discharge channel. By providing the first top cap, unintentional discharge of the fluid in the measuring bucket during an overturning process is prevented.

Preferably, the measuring bucket is provided with an adjusting member for adjusting a volume of the second compartment, wherein a second compartment base of the second compartment is a movable base.

In accordance with another aspect of the invention, the present invention provides a bottle arrangement, comprising: a bottle body defining a receiving chamber having a bottle opening and a bottle base, and an overturning device for measuring and dispensing fluid, wherein the measuring bucket is mounted at the bottle opening, wherein the first compartment is communicated with the receiving chamber, wherein the backflow channel is communicated with the receiving chamber.

In accordance with another aspect of the invention, the present invention provides a bottle arrangement comprising a bottle body, a top cap, a first partition panel, a second partition panel, and a third partition panel, wherein the bottle body comprises a bottle base and a bottle wall, wherein the top cap is capped on a top side of the bottle wall, wherein the first partition panel and the second partition panel, which are extended upward from the bottle base, are fastened with the bottle wall, wherein the third partition panel is extended downward from a top portion of the bottle wall, wherein the first partition panel, the bottle base, and the bottle wall are enclosed to define a receiving chamber, wherein the second partition panel, the bottle base, and the bottle wall are enclosed to define a measuring-dispensing chamber, wherein the first partition panel, the third partition panel, and the bottle wall are enclosed to define a temporary storing chamber and a communicating channel, wherein the third partition panel and the bottle wall are enclosed to define a discharge channel, wherein the communicating channel communicates the temporary storing chamber to the measuring-dispensing chamber, wherein the measuring-dispensing chamber has a backflow opening, wherein the first backflow chamber communicates the backflow opening to the temporary storing chamber, so that the fluid overflowing from backflow opening of the measuring-dispensing chamber is capable of flowing into the first backflow chamber.

The overturning device for measuring and dispensing fluid comprises a measuring bucket for mounting above a bottle body, wherein the measuring bucket has a measuring-dispensing chamber, a discharge channel, an inlet channel for guiding the fluid in the bottle body to flow into the measuring-dispensing chamber, and a backflow channel for guiding the fluid in the measuring-dispensing chamber to flow back into the bottle body, wherein the measuring-dispensing chamber has a base wall at a bottom side thereof, and a backflow opening for calibrating a volume of the measuring-dispensing chamber, wherein the inlet channel is communicated with the measuring-dispensing chamber, wherein the discharge channel communicates the measuring-dispensing chamber to outside, wherein the backflow channel is communicated with the backflow opening, wherein the backflow channel and the inlet channel are both partitioned from the discharge channel, wherein the discharge channel is provided above the measuring-dispensing chamber, so that the fluid overflowing from the backflow opening of the measuring-dispensing chamber is guided to flow into the backflow channel. The inlet channel has a sequence of an inlet chamber and a temporary storing chamber for communicating with the bottle body, and a communicating channel for communicating with the measuring-dispensing chamber. An inner diameter of the temporary storing chamber can be larger than inner diameters of the inlet chamber and the communicating channel. The measuring bucket comprises a first measuring bucket and a second measuring bucket, the inlet chamber, communicating channel, the temporary storing chamber and the backflow channel are provided in the first measuring bucket. The measuring-dispensing chamber and the discharge channel are provided in said second measuring bucket. The first measuring bucket comprises a first base panel and a ring-shaped first enclosing pane, a ring-shaped second enclosing panel and a ring-shaped third enclosing panel provided on the first base panel in an inside to outside manner. The inlet channel penetrates the first base panel. The temporary storing chamber is defined by the base panel and the first enclosing panel. The inlet channel is provided in the temporary storing chamber. The communicating channel, which is defined by the first enclosing panel, the second enclosing panel, and the first base panel, is respectively communicated with the temporary storing chamber and the inlet opening of the measuring-dispensing chamber at two ends thereof. The backflow channel is defined by the second enclosing panel, the first base panel, and the third enclosing panel. A communicating hole is provided in the first base panel. The backflow channel has an end communicated with the receiving chamber through the communicating hole and another end communicated with the backflow opening of the measuring-dispensing chamber. The backflow opening and the inlet opening of the measuring-dispensing chamber are partitioned from each other, and in the gravity direction, a position of the inlet opening is higher than or equal to a position of the backflow opening. The measuring bucket comprises a first measuring bucket and a second measuring bucket, wherein the measuring-dispensing chamber has an inlet opening having a position higher than a position of the backflow opening. The temporary storing chamber, the inlet chamber and the backflow chamber are partitioned from each other by partition walls. The second measuring bucket is hung on an outer side of the first measuring bucket by means of an inlet tube and a backflow tube. The inlet tube is respectively communicated with the inlet opening and the temporary storing chamber at two ends thereof. The backflow tube is respectively communicated with the backflow opening and the backflow chamber at two ends thereof.

The present invention is advantageous in that because the measuring-dispensing chamber is provided with a backflow opening communicated with the bottle body or the first compartment by the backflow channel, so that when measuring and dispensing fluid, the surplus fluid will flow back into the bottle body or the first compartment through the backflow opening and the backflow channel when a fluid level of the fluid in the measuring-dispensing channel is even with the backflow opening. A volume of the fluid in each measuring and dispensing process can be a volume of the second compartment, so that accuracy of the measure and dispense is enhanced.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a bottle arrangement according to a first preferred embodiment of the present invention.

FIG. 2 is another perspective view of the bottle arrangement according to the above first preferred embodiment of the present invention.

FIG. 3 is a sectional view illustrating the bottle arrangement when the second top cap is being opened according to the above first preferred embodiment of the present invention.

FIG. 4 is a perspective view illustrating the bottle arrangement without the top cap according to the above first preferred embodiment of the present invention.

FIG. 5 is a sectional view illustrating a bottle arrangement in an upright state according to a second preferred embodiment of the present invention.

FIG. 6 is a sectional view illustrating the bottle arrangement in an upside-down state according to the above second preferred embodiment of the present invention.

FIG. 7 is a sectional view illustrating a bottle arrangement in an upright state according to a third preferred embodiment of the present invention.

FIG. 8 and FIG. 9 are respectively exploded views from different viewing angles of a bottle arrangement according to a fourth preferred embodiment of the present invention.

FIG. 10 is a sectional view of the bottle arrangement according to the above fourth preferred embodiment of the present invention.

FIG. 11 and FIG. 12 are respectively exploded views from different viewing angles of a bottle arrangement according to a fifth preferred embodiment of the present invention.

FIG. 13 a front view of the bottle arrangement according to the above fifth preferred embodiment of the present invention.

FIG. 14 is a sectional view along line C-C in FIG. 13.

FIG. 15 is a top view of the bottle arrangement according to the above fifth preferred embodiment of the present invention.

FIG. 16 and FIG. 17 are respectively sectional views along line B-B and line A-A.

FIG. 18 is an exploded view of a measuring and dispensing device of a bottle arrangement according to a six preferred embodiment of the present invention.

FIG. 19 is a sectional view of the bottle arrangement (without a top cap) according to the above preferred embodiment of the present invention.

FIG. 20 is a sectional view along line D-D in FIG. 19.

FIG. 21 is an exploded view of a bottle arrangement according to the seventh preferred embodiment of the present invention.

FIG. 22 is a perspective view of the bottle arrangement according to the above seventh preferred embodiment of the present invention.

FIG. 23 is a sectional view illustrating the bottle arrangement being overturned for a first time according to the above seventh preferred embodiment of the present invention.

FIG. 24 is a sectional view illustrating the bottle arrangement being overturned for a second time according to the above seventh preferred embodiment of the present invention.

FIG. 25 is a sectional view illustrating the bottle arrangement being overturned for a third time according to the above seventh preferred embodiment of the present invention.

FIG. 26 is a perspective view of a bottle arrangement according to an eighth preferred embodiment of the present invention.

FIG. 27 and FIG. 28 are respectively exploded views from different viewing angles of the bottle arrangement according to the above eighth preferred embodiment of the present invention.

FIG. 29 is a sectional view illustrating the bottle arrangement being overturned for a first time according to the above eighth preferred embodiment of the present invention.

FIG. 30 is a sectional view illustrating the bottle arrangement being overturned for a second time according to the above eighth preferred embodiment of the present invention.

FIG. 31 is a sectional view illustrating the bottle arrangement being overturned for a third time according to the above eighth preferred embodiment of the present invention.

FIG. 32 is a sectional view of the bottle arrangement according to the above eighth preferred embodiment of the present invention.

### DETAILED DESCRIPTION OF THE PREFERRED EMBODIMENT

The following description is disclosed to enable any person skilled in the art to make and use the present invention. Preferable embodiments are provided in the following description only as examples and modifications will be apparent to those skilled in the art. The general principles defined in the following description would be applied to other embodiments, alternatives, modifications, equivalents, and applications without departing from the spirit and scope of the present invention.

### Embodiment 1

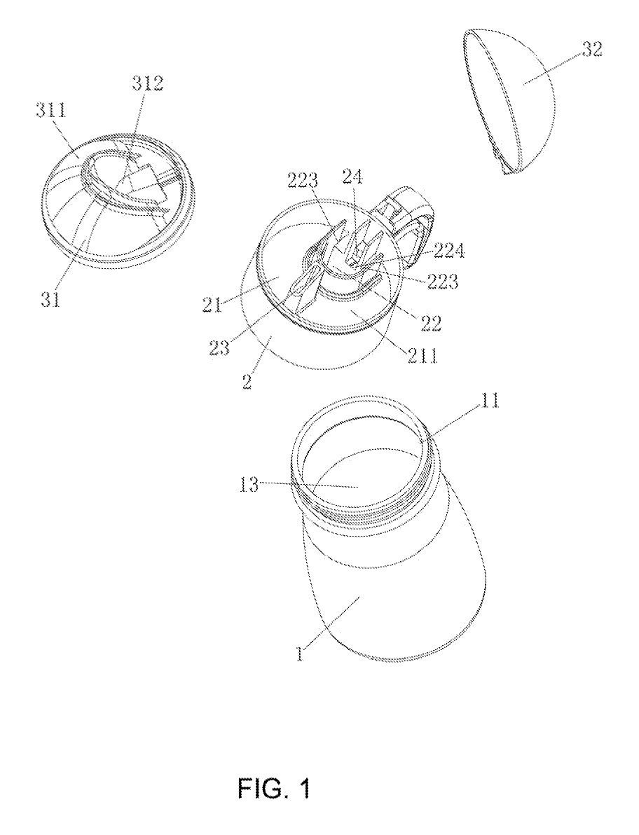

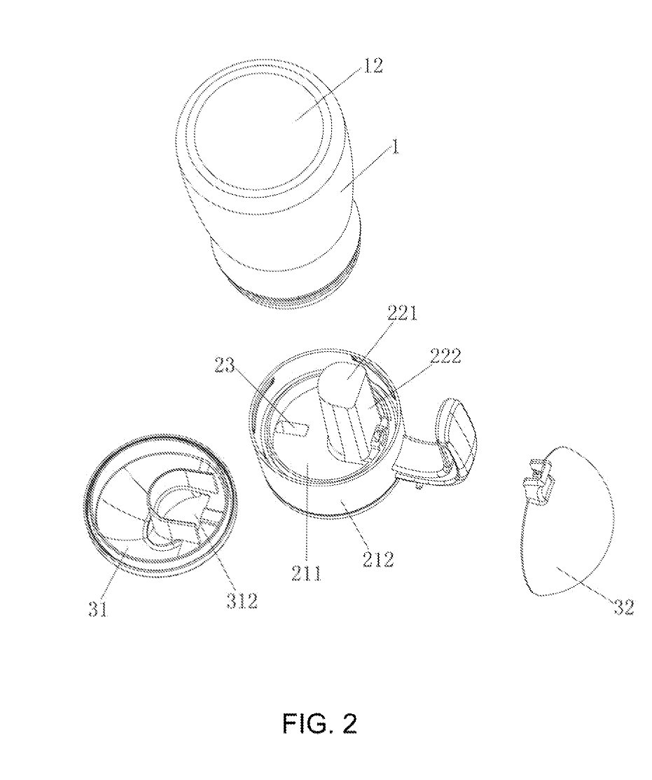

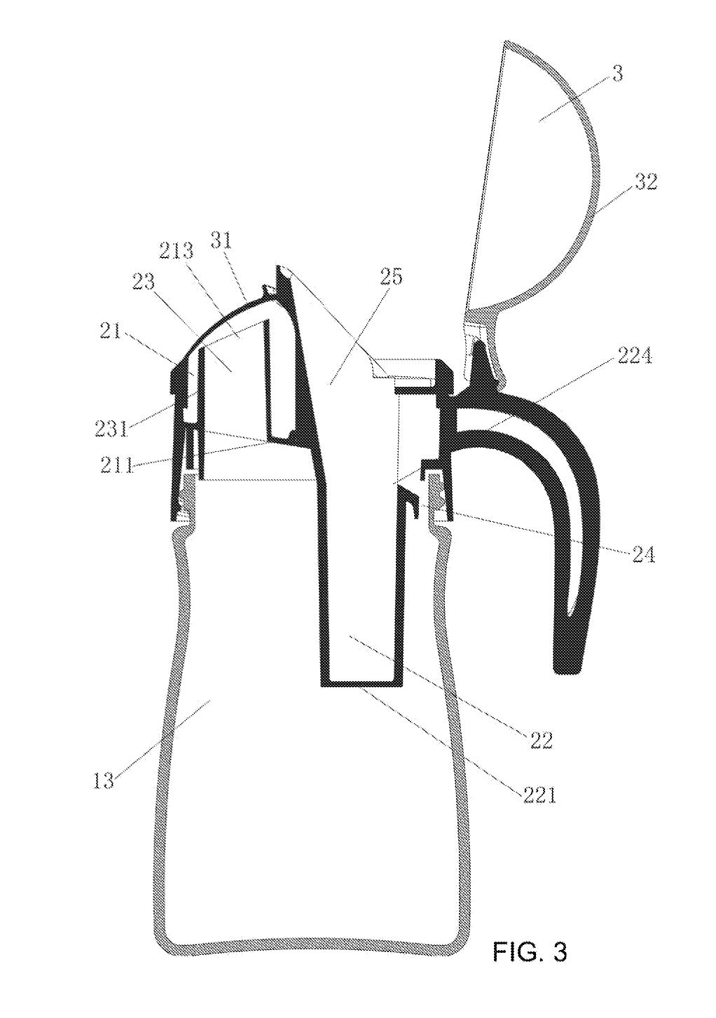

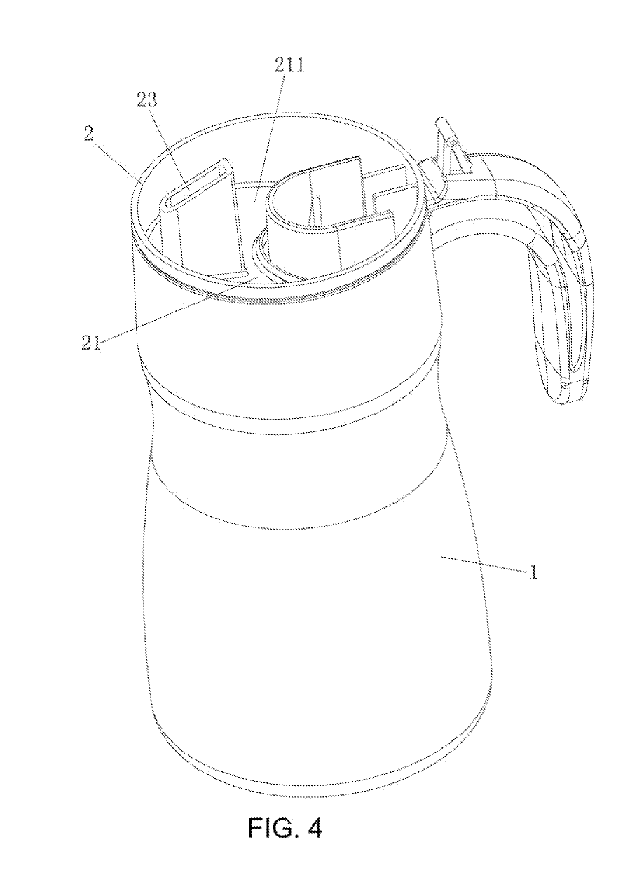

Referring to FIG. 1 to FIG. 4 of the drawings, a bottle arrangement according to a first preferred embodiment of the present invention is illustrated. The bottle arrangement comprises a bottle body 1, a measuring bucket 2, and a top cap 3. The bottle body 1 has a receiving chamber 13 having a bottle base 12 at a bottom side thereof and a bottle opening 11 at a top side thereof.

The measuring bucket 2, which is mounted at the bottle opening 11 of the bottle body, has a first compartment 21, a second compartment 22, an inlet channel 23, a backflow channel 23, and a discharge channel 25. The first compartment 21 is defined by a first compartment base 211 and a first compartment wall 212 having a ring-shaped cross section. The first compartment base 211 closes and seals a bottom side of the first compartment wall 212, wherein the compartment wall 212 has an opening 213 provided at a bottom side thereof. The first compartment base 211, which is capable of guiding fluid to flow under the influence of gravity, may have a slanted surface which is inclinedly provided. The second compartment 22 is defined by a second base 221 and a second compartment wall 222 having a ring-shaped cross section. The second compartment wall 222 has an inlet opening 223 and a backflow opening 224 which are provided above the second compartment base. A position of the inlet opening 223 is not lower than a position of the backflow opening 224, preferably the position of the inlet opening 223 is higher than the position of the backflow opening 224. The inlet opening, which is provided at a lower position of the first compartment, facilitates the fluid to flow from the first compartment into the second compartment. The inlet channel can be provided a lower position of the first compartment. By providing the backflow opening, the second compartment is constructed to have a predetermined volume. The inlet channel 23, which is defined by a third wall 231 having a ring-shaped cross section, is arranged in an up-down penetration manner and has a bottom opening communicated with the receiving chamber. The inlet channel 23 has a top opening provided at a position higher than the second compartment wall. The third compartment wall 231 can be integrated with the first compartment base 211. The backflow channel 24 communicates the backflow opening to the receiving chamber of the bottle body. The discharge channel 25 through which the fluid in the second compartment 22 is discharged is provided above the second compartment. The inlet channel 23 and the backflow channel 24 are respectively provided at two sides of the second compartment 22.

The top cap 3 comprises a first top cap 31 and a second top cap 32. The first top cap 31, which is capped above the measuring bucket 2, has a sealing portion 311 and a discharge opening 312. The sealing portion 311 closes and seals the top opening 213 of the first compartment 21 and the top opening of the inlet channel 23. The discharge opening communicates the discharge channel to outside. The second top cap 32, which is capped above the first top cap 31, can be rotatably coupled with bottle body 1. The second top cap 32 has a close position at which the second top cap 32 closes and seals the discharge opening for cutting off the communication between the discharge channel and the outside (i.e. the fluid cannot exit therethrough)and an open position at which the second top cap 32 moves away from the discharge opening so that the discharge channel is communicated with the outside (i.e. the fluid can exit therethrough), the “outside” herein is referred to the outside environment of the bottle arrangement.

In an initial state, the fluid is stored in the receiving chamber 13 and the bottle arrangement is in an upright state. At this time, the bottle arrangement can be vertically placed. When dispensing the fluid, the bottle arrangement is overturned for a first time and during the overturning process, the first top cap 31 is capped on the measuring bucket 2, the second top cap 32 is capped on the first top cap 31. When the measuring bucket 2 is overturned to be in an upside-down state, under the influence of gravity, the fluid in the receiving chamber 13 flows into the first compartment 21 through the inlet channel 23. And then, the bottle arrangement is overturned for a second time so that the measuring bucket 2 is back to the upright state, under the influence of gravity, the fluid in the first compartment 21 is guided along the first compartment base 211 flow into the second compartment 22 through the inlet opening. During the flowing process, when the first compartment 21 is full of fluid (i.e. amounts to the predetermined volume of the first compartment 21), the fluid continually flowing into the first compartment 21 flows back into the receiving chamber through the backflow opening 224 and the backflow channel 24. Finally, the bottle arrangement is overturned for a third time and during the overturning process, the second top cap 32 is opened, the measuring bucket 2 is overturned to be in the upside-down sate, the fluid in the second compartment exits to the outside through the discharge channel 25 under the influence of gravity. At the same time, the fluid in the receiving chamber 13 refills the first compartment 21.

By providing the backflow opening and the backflow channel, the surplus fluid is back flowed so that a precise measuring and dispensing of the fluid is obtained. Since the fluid in the measuring bucket is simultaneously undergoing the discharging process and the charging process, the entire charging-discharging process is coherent and the efficiency is increased.

According to the bottle arrangement of this preferred embodiment, the measuring bucket has an upright state in which the fluid in the first compartment is capable of flowing into the second compartment and an upside-down state in which the fluid in the first compartment cannot flow into the second compartment. When in the upright sate, in a direction of gravity, the measuring bucket and the bottle opening of the bottle body are facing upward, the word “upward” herein comprises directions of vertically upward and inclinedly upward; when in the upside-down state, the measuring bucket and the bottle opening of the bottle body are facing downward, the word “downward” herein comprise directions of inclinedly downward and vertically downward. The first compartment through which a temporary storage of the fluid is obtained can be interpreted as a temporary storing compartment; the second compartment through which a precise measure and dispense of the fluid is obtained can be interpreted as a measuring and dispensing compartment. The inlet channel, which communicates the bottle body with the first compartment, is constructed as a passage route for the fluid to flow from the receiving chamber into the first compartment. The first compartment is communicated with the inlet opening of the second compartment. The backflow channel, which communicates the backflow opening to the receiving chamber of the bottle body, is embodied as a passage route for the fluid to flow from the inlet opening into receiving chamber of the bottle body. The discharge channel communicates the second compartment to outside. The inlet channel and the first compartment together form an integral inlet passage communicating the bottle body to the second compartment. A volume of the first compartment can be larger than a volume of the second compartment.

### Embodiment 2

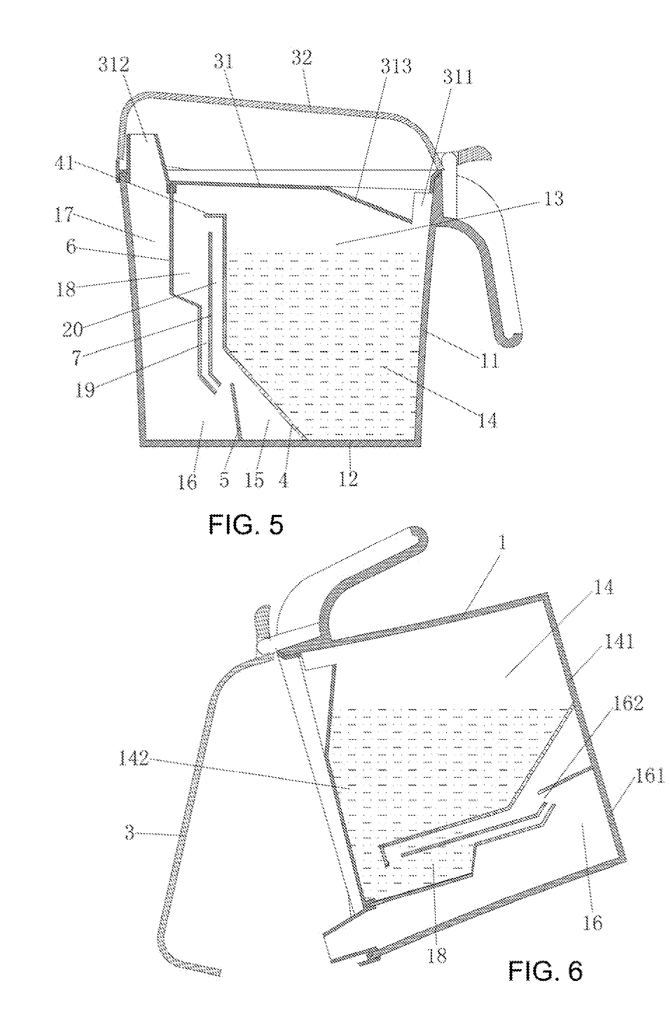

Referring to FIG. 5 and FIG. 6 of the drawings, a bottle arrangement according to a second preferred embodiment comprises a bottle body 1 comprising a bottle wall 11, a bottle base 12. A receiving chamber 13 is enclosed and defined by the bottle wall and the bottle base 12. A first partition panel 4, a second partition panel 5, a third partition panel 6, and a fourth partition panel 7 are provided in the receiving chamber 13. The first partition panel 4 is extended upward from the bottle base 12 and is mounted to the bottle wall 11. The second partition panel 5 is extended upward from the bottle base 12 and is mounted to the bottle wall 11. The third partition panel 6 is extended downward from the bottle wall 11 and is mounted to the bottle wall 11. The fourth partition panel 7 is mounted to the bottle wall and is provided between the first partition panel 4 and the third partition panel 6. The first partition panel 4, the bottle base 12 and the bottle wall are enclosed to define a receiving cavity 14 having a first bottom portion 141 at a bottom side thereof and a first opening 142 at a top side thereof. The first partition panel 4, the second partition panel 5, the bottle base 12, and the bottle wall 11 are enclosed to define a first backflow cavity 15 having a closed bottom side. The second partition panel 5, the bottle base 12, and the bottle wall 11 define a measuring-dispensing cavity 16. The third partition panel 6 and the bottle wall 11 are enclosed to define a discharge passage 17. The first partition panel 4, the fourth partition panel 7, and the bottle wall 11 are enclosed to define a second backflow cavity 20 which is arranged in an up-down penetration manner. The fourth partition panel 7, the third partition panel and the bottle wall 11 are enclosed to define a temporary storing cavity 18 and a communicating channel 19 which is provided under the temporary storing cavity 18 for communicating the temporary storing cavity 18 to the measuring-dispensing cavity 16. The second backflow cavity 20 is communicated with the first backflow cavity 15. The measuring-dispensing cavity 16, which has a predetermined volume, has a second bottom portion 161 at a bottom side thereof and a backflow opening 162 at a top side thereof. The backflow opening 162 is even with the top side of the third partition panel 6. An inner diameter of the temporary storing cavity 18 is larger than an inner diameter of the communicating channel 19, and in a direction of gravity, an upper portion of the temporary storing cavity 18 has a larger inner diameter than an inner diameter of an lower portion thereof. In addition, in order to prevent the fluid in the temporary storing cavity 18 from unintentionally flowing into the second backflow cavity 20, a blocking panel 41 is provided on top of the first partition panel 4 extending towards the third partition panel 6. The first bottom portion and the second bottom portion is respectively a portion of the bottle base of the bottle body.

The temporary storing cavity 18 has a top portion and a bottom portion respectively communicated with the receiving cavity 14 and the communicating channel 19. The bottom portion of the communicating channel 19 is communicated with the measuring-dispensing cavity 16. A top portion and a bottom portion of the discharge passage 17 are respectively communicated to outside and the measuring-dispensing cavity 16. The communicating channel 19 and the temporary storing cavity are partitioned from each other by the fourth partition panel 7 and the second backflow cavity 20. The communicating channel 19 and the temporary storing cavity are partitioned from each other by the third partition panel 6 and the discharge passage 17. The receiving cavity 14 and the first backflow cavity 15 are partitioned by the first partition panel 4. The measuring-dispensing cavity 16 is partitioned from the first backflow cavity 15 by the second partition panel 5.

The end cap 3 comprises a first end cap 31 and a second end cap 32. The first end cap has an inlet opening 311 and a discharge opening 312. A slanted surface 313 is provided in the inlet opening for guiding the filling fluid and preventing the fluid to unintentionally exit the bottle body when the fluid is discharged. The discharge opening 312 is communicated with the discharge passage 17. The first end cap 31 is capped on the bottle body 1. The second end cap 32, which is provided above the first end cap 31, is pivotally connected to the bottle body through a rotation axis and is adapted to move between an open position and a closed position.

When in use, the second end cap is opened, the bottle body is in an upright sate, the fluid is filled into the receiving cavity 13 of the bottle body through the inlet opening of the first end cap. When measuring and dispensing the fluid, the bottle body is overturned for a first time so that the bottle body is inclined downward so that the bottle body is in an upside-down state, during the overturning process, part of the fluid in the receiving cavity flows into and fill up the temporary storing cavity 18. And then, the bottle body is overturned again so that the bottle body returns to the upright state. The fluid in the temporary storing cavity falls into the measuring-dispensing cavity 16, the surplus fluid climbs over the thirds partition panel and flows into the first backflow cavity and is temporarily stored therein. And again, the bottle body is overturned, so that the bottle body is back to the state in which the bottle body is inclined arranged for the fluid in the measuring-dispensing cavity 16 to exit the bottle body through the discharge passage 17 and the discharge opening. At the same time, the fluid in the first backflow cavity flows into the temporary storing cavity through the second backflow cavity 20, and part of the fluid in the receiving cavity flows into the temporary storing cavity.

In this preferred embodiment, the measuring-dispensing cavity 16 has a predetermined volume. When the fluid fills up the measuring-dispensing cavity 16, the surplus fluid overflows into the first backflow cavity and then flows back by means of the first backflow cavity and the second backflow cavity. Since when the fluid is discharged, the fluid in the receiving cavity refills the temporary storing cavity, so that the measuring and dispensing process can be carried out continuously.

In this preferred embodiment, the first backflow cavity and the second backflow cavity form a backflow passage having a bottom portion, so that the fluid overflowing from the measuring-dispending cavity can be temporary stored in the backflow passage.

In this preferred embodiment, a volume of the temporary storing cavity is preferred to larger than a volume of the measuring-dispensing cavity.

### Embodiment 3

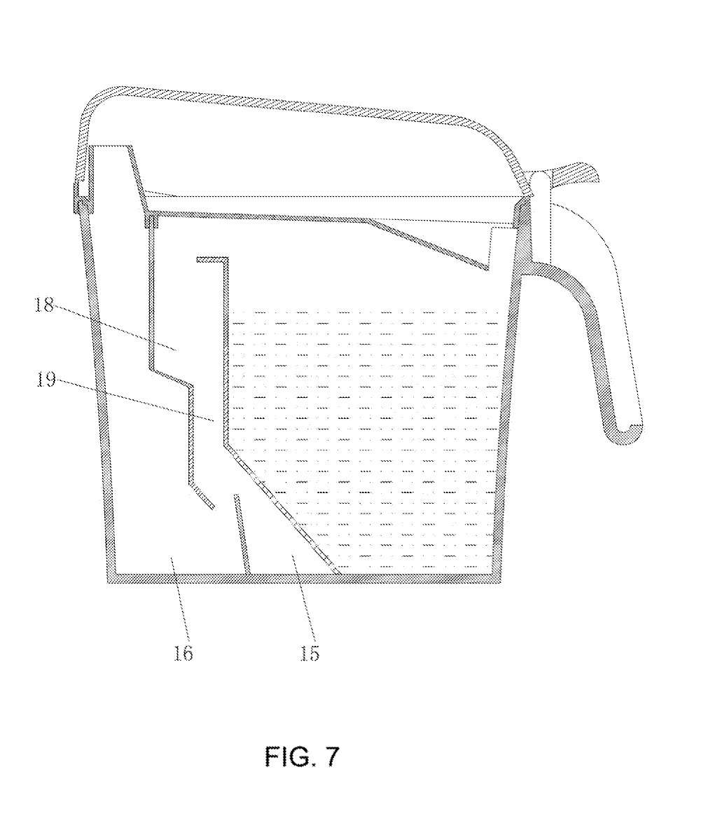

Referring to FIG. 7 of the drawings, the bottle arrangement according to a third preferred embodiment has a similar structure with the bottle arrangement of the second preferred embodiment except the following differences. The fourth partition panel is eliminated in this preferred embodiment. In other words, the first backflow cavity 15 is directly communicated with the temporary storing cavity 16. When filling the fluid, the fluid in the temporary cavity 18 flows into the measuring-dispensing cavity 16 through the communicating channel 19. The surplus fluid in the measuring-dispensing cavity 16 flows into the first backflow cavity for temporary storage. When overturned again, the fluid in the first backflow cavity flows back into the temporary cavity 18 through the communicating channel 19.

### Embodiment 4

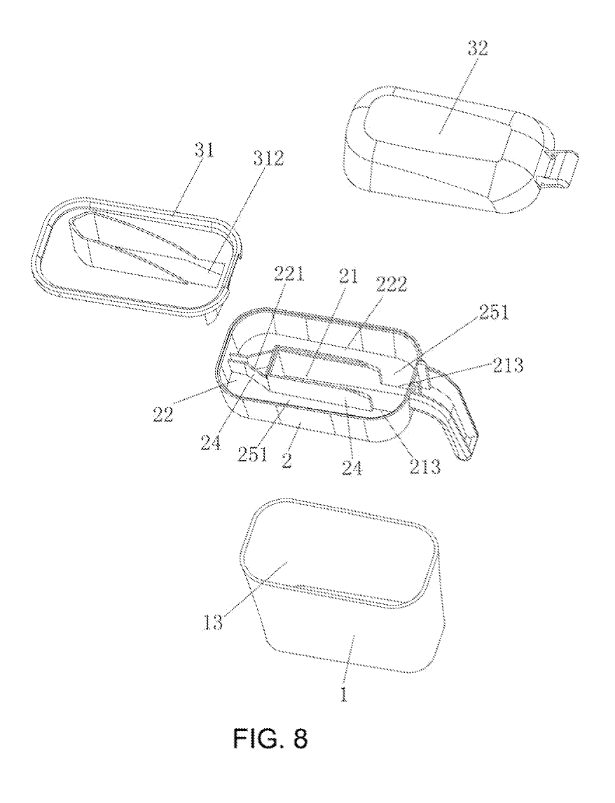

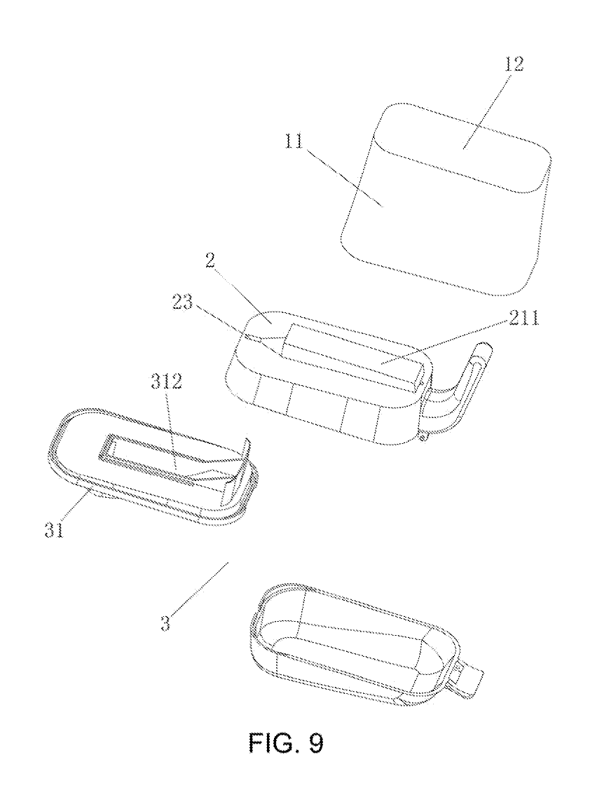

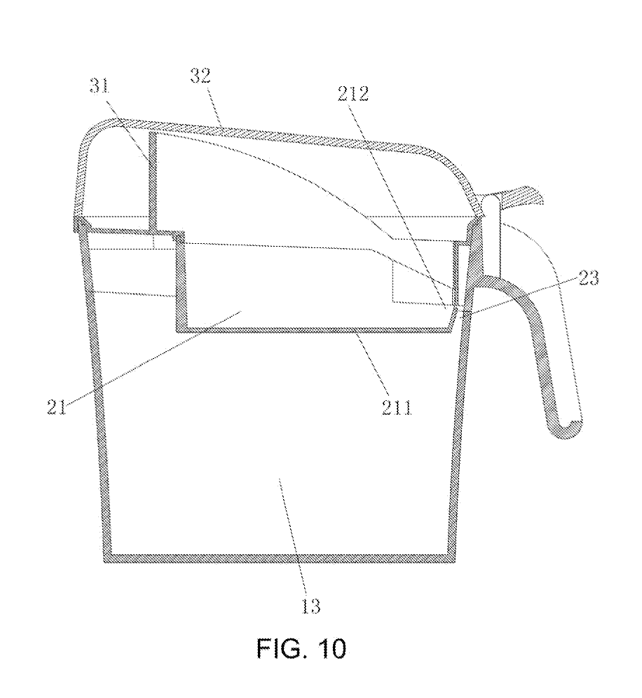

Referring FIG. 8 to FIG. 10 of the drawings, a bottle arrangement according to this preferred embodiment comprises a bottle body 1, a measuring bucket 2, and an end cap 3. The bottle body 1 has a bottle wall 11 and a bottle base 12. A receiving cavity 13 is enclosed and defined by the bottle wall 11 and the bottle base 12.

The measuring bucket 2 has a measuring-dispensing chamber 21, inlet channel 22 and a backflow channel 23. The inlet channel 22 and the measuring-dispensing chamber 23 are partitioned from each other by a partition wall 24. The measuring-dispensing chamber 21 has a first chamber base 211 at a bottom side thereof, an inlet opening 213 at a top side thereof, and a backflow opening 212 below the inlet opening 213. The inlet opening 213 and the backflow opening 212 are both provided at positions higher than a position of the first chamber base 211. The inlet channel 22 has an inlet chamber 221 and a temporary storing chamber 222 which are communicated with each other. The inlet chamber 221 is arranged in an up-down penetration manner. The temporary chamber 222 has a second chamber base 251. The measuring-dispensing chamber 21 can be provided with two inlet openings 213 so that the fluid in the temporary storing chamber 222 can be divided into two streams of flow flowing into the measuring-dispensing chamber 21. The inlet chamber 22 and the backflow chamber 23 are respectively provided at two sides of the measuring-dispensing chamber 21.

The end cap 3 comprises a first end cap 31 and a second end cap 32. The first end cap 31 is capped on the measuring bucket 2 and has a penetrating discharge opening 312 which is communicated with the measuring-dispensing chamber. The first end cap 31 can be covered on the temporary storing chamber and the inlet chamber, so that unintentional discharge of the fluid when the bottle body is overturned is prevented.

In an initial state, the fluid is stored in the receiving chamber 13. When measuring and dispensing the fluid, the bottle body is overturned for a first time so that the bottle body and the measuring bucket are in an upside-down state, part of the fluid in the receiving chamber 13 flows into the temporary storing chamber 222 through the inlet chamber under the influence of gravity. And then, the bottle body is overturned for a second time so that the bottle body and the measuring bucket are in an upright state in which the fluid in the temporary storing chamber 22 flows along the second chamber base 251 and gets into the measuring-dispensing chamber 21 through the inlet opening 213. During this overturning process, the fluid overflowing from the backflow opening 212 flows back into the receiving chamber 13 of the bottle body through the backflow channel 23. And again the bottle body is overturned so that the bottle body and the measuring bucket are back to be in the upside-down state in which the fluid in the measuring-dispensing chamber 21 is discharged through the discharge channel 26 and the discharge opening 312 of the first end cap. At the same time, part of the fluid in the receiving chamber flows into the temporary storing chamber 222 through the inlet chamber 221.

### Embodiment 5

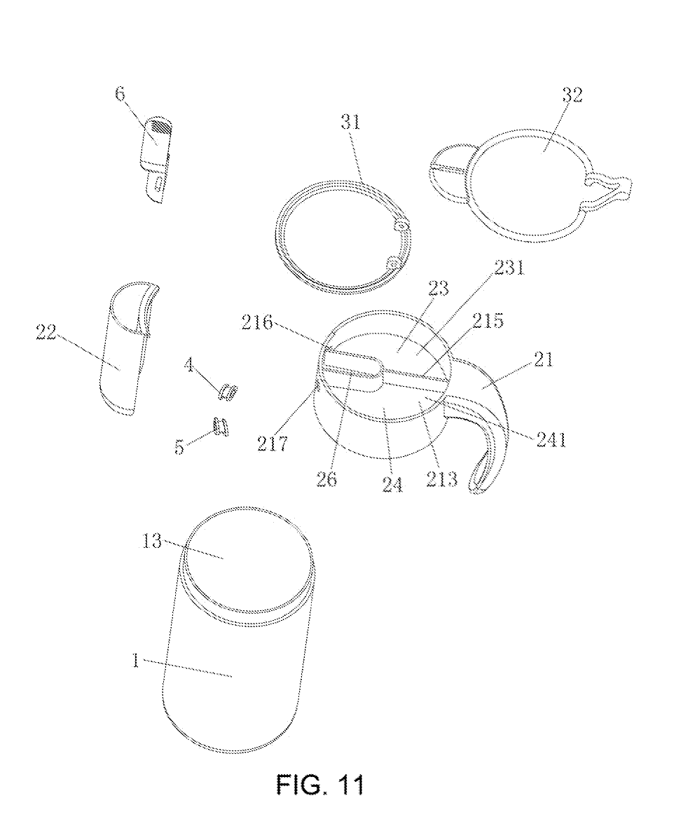

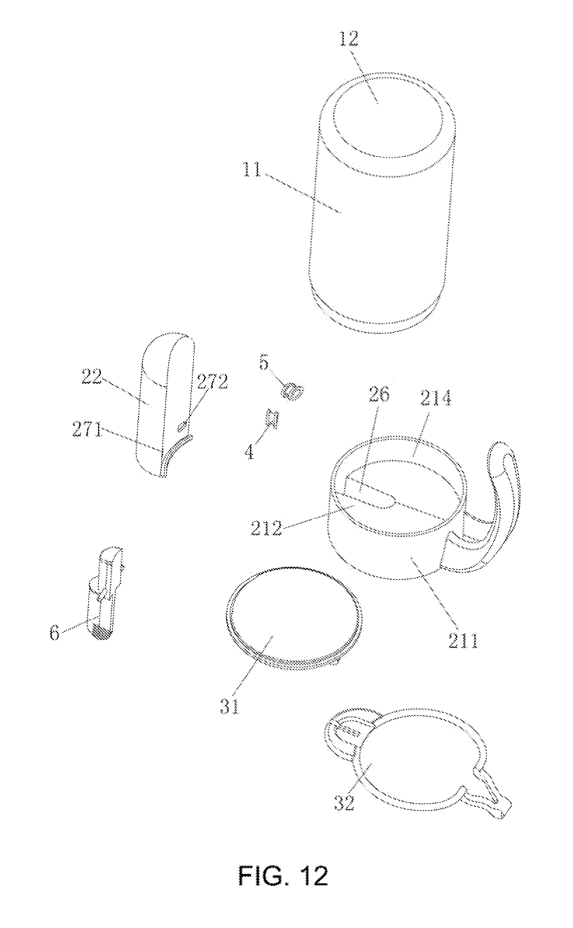

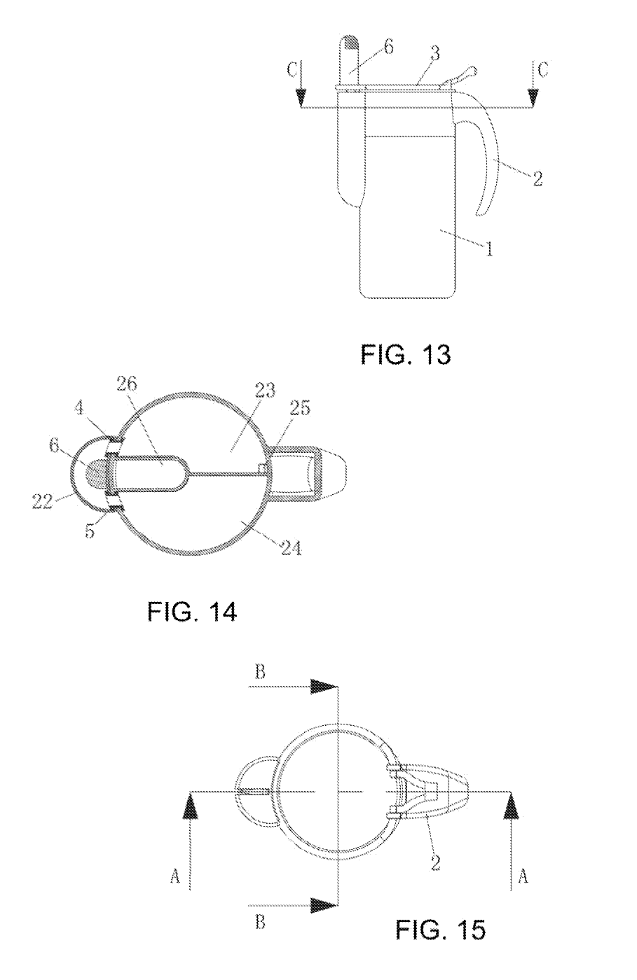

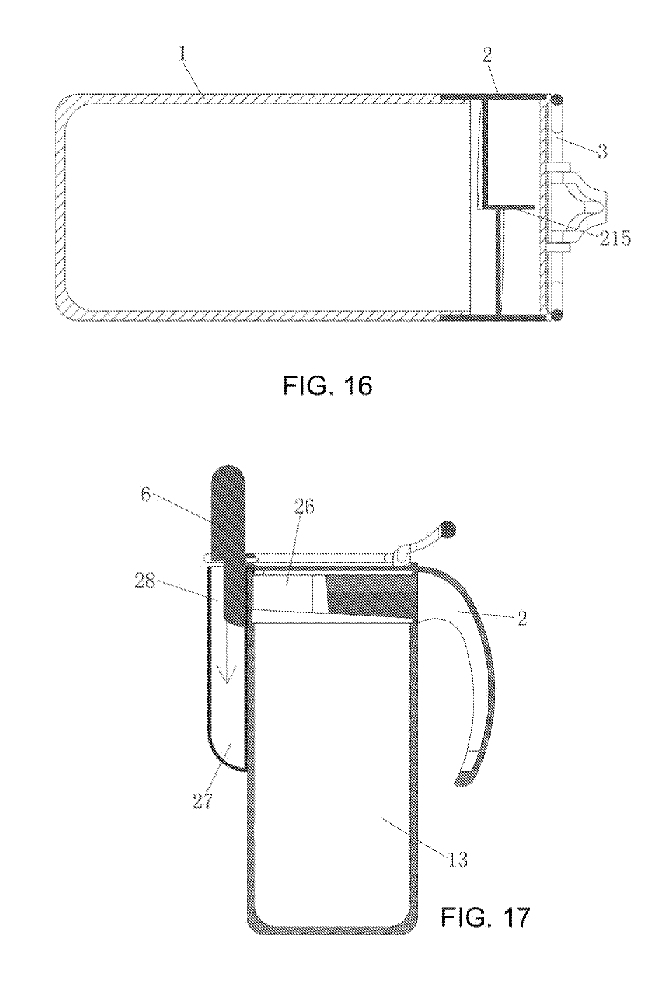

Referring to FIG. 11 to FIG. 17 of the drawings, a bottle arrangement according to this preferred embodiment comprises a bottle body 1, a measuring bucket 2 and a top cap 3. The bottle body 1 has a bottle wall 11 and a bottle base 12. A receiving cavity 13 is enclosed and defined by the bottle wall 11 and the bottle base 12.

The measuring bucket 2 comprises a first measuring bucket 21 and a second measuring bucket 22. The first measuring bucket 21 comprises a ring-shaped encircling wall 211 and a middle wall 212 provided in the ring-shaped encircling wall 211. The ring-shaped encircling wall 211 is integrated with the middle wall 212 to form a one piece structure. The middle wall 212 has an upper surface and a lower surface. The upper surface and the encircling wall 211 define an upper chamber 213, the lower surface and the encircling wall 211 define an lower chamber 214. A partition wall 215 is protruded from the upper surface in such a manner that the upper chamber 213 is divided into a first backflow chamber 23 having a first chamber base 231 and a temporary storing chamber 24 having a second chamber base 241 which are not communicated with each other. The first backflow chamber 23 is communicated with the receiving chamber 23 through the second backflow chamber 25. The first measuring bucket 21 is further provided with an inlet chamber 26 which is extended from the inner surface to penetrate the partition wall 215. The encircling wall 211 has a first backflow opening 216 communicated with the first backflow chamber 23 and a first inlet opening 217 communicated with the temporary storing chamber 24. The second measuring bucket 22 has a measuring-dispensing chamber 27 and a discharge channel 28 provided above the measuring-dispensing chamber 27. The chamber wall of the measuring-dispensing chamber 27 is provided with a second inlet opening 271 and a second backflow opening 272. Two end portions of a backflow tube 4 are respectively inserted into the first backflow opening 271 and the second backflow opening 272, two end portions of a temporary storing tube 5 are respectively inserted into the first inlet opening 217 and the second inlet opening 272, so that the second measuring bucket is hung on at an outer side of the first measuring bucket 21. The second inlet opening 272 of the second measuring bucket is provided at a position above the second backflow opening 271 in the gravity direction. The first chamber base 231 can be embodied as a slanted surface that is capable of guiding the fluid to flow back into the second backflow chamber 25. The second chamber base 241 can be embodied as another slanted surface that is capable of guiding the fluid to flow into the measuring-dispensing chamber 27 having an inclining angle opposite an inclining angle of the first chamber base 231. The first backflow chamber 23 and the second backflow chamber 25 are communicated with each other to form a backflow passage communicating the second backflow opening 271 of the measuring-dispensing chamber to the receiving chamber 13 of the bottle body.

The top cap 3 comprises a first top cap 31 and a second top cap 32. The first top cap 31 is detachably mounted on a top side of the first measuring bucket 21 to close and seal the upper chamber 213 of the first measuring bucket 21. The second top cap 32 is pivotally connected to the first top cap 31 via a rotation axis so that the second top cap 32 can be moved between an open state and closed state.

In addition, the second measuring bucket 22 is further provided with an adjusting member 6 for adjusting a volume of the measuring-dispensing chamber 27. When the adjusting member 6 is lifted up, the actual volume of the measuring-dispensing chamber 27 is increased; when the adjusting member 6 is pressed downward, the actual volume of the measuring-dispensing chamber 27 is decreased. The volume of the measuring-dispensing chamber 27 is not changed, but by controlling the inserting depth of the adjusting member in the measuring-dispensing chamber, the actual volume available for receiving fluid in the measuring-dispensing chamber can be altered.

When in use, the bottle body is overturned for several times, so that part of the fluid in receiving chamber flows into the temporary storing chamber 24 through the inlet chamber 26 of the first measuring bucket 21, and then the fluid in the temporary storing chamber 24 flows into the measuring-dispensing chamber 27 of the second measuring bucket 22 through the temporary storing tube 5. The fluid climbing over the second backflow opening 271 from the measuring-dispensing chamber 27 can flow back into the receiving chamber through the backflow tube 4 and the backflow chamber 23.

In this preferred embodiment, the temporary storing chamber and the measuring-dispensing chamber both have a chamber base and a chamber wall, while the inlet channel and the backflow channel are penetrating structure. The second backflow opening of measuring-dispensing chamber and the backflow channel are provided at higher positions of the measuring bucket, so that when the measuring bucket is in the upside-down state, the fluid in the receiving chamber cannot flow into the measuring-dispensing chamber.

### Embodiment 6

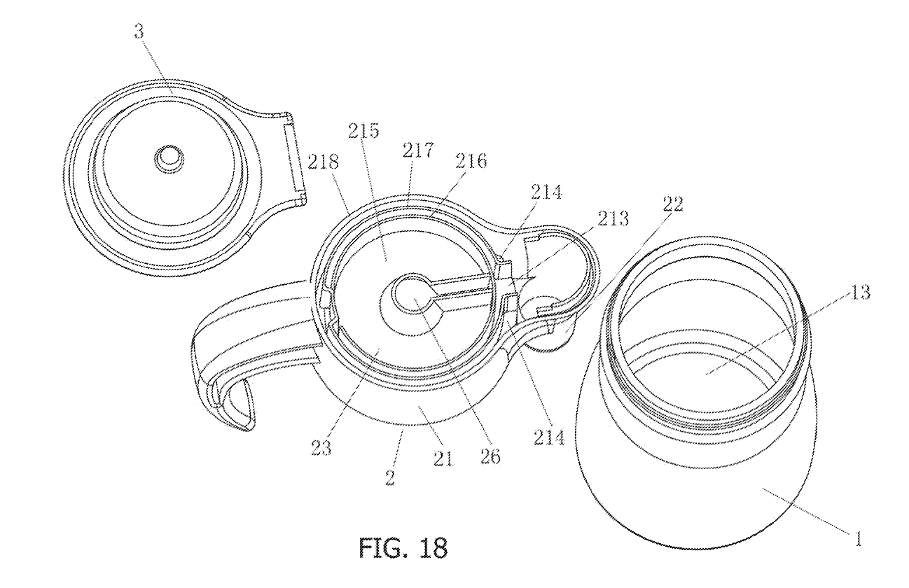

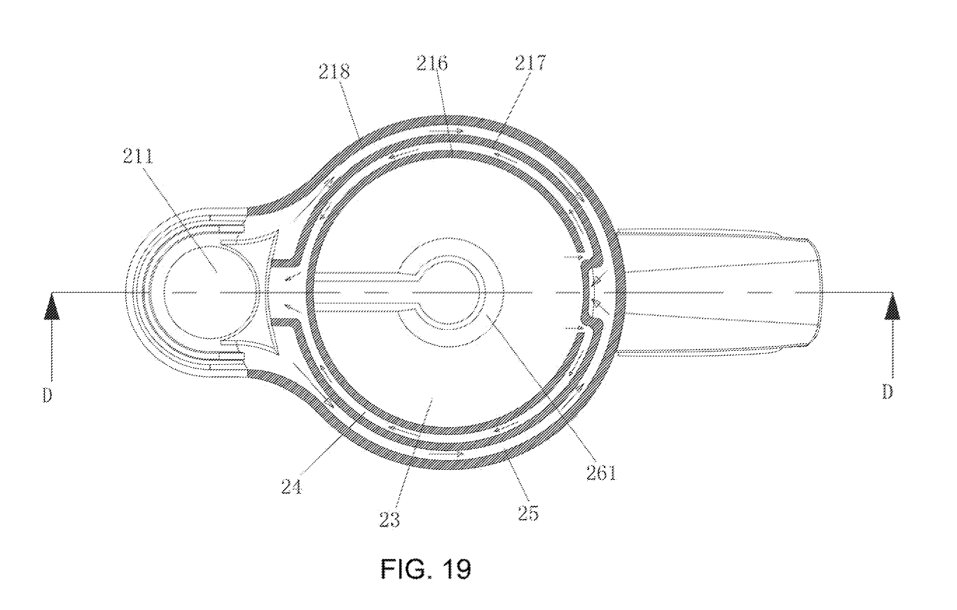

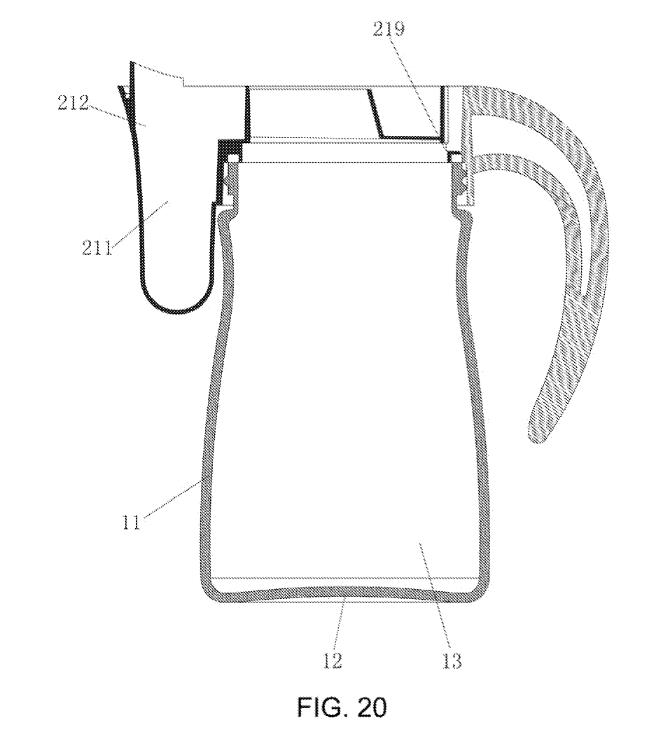

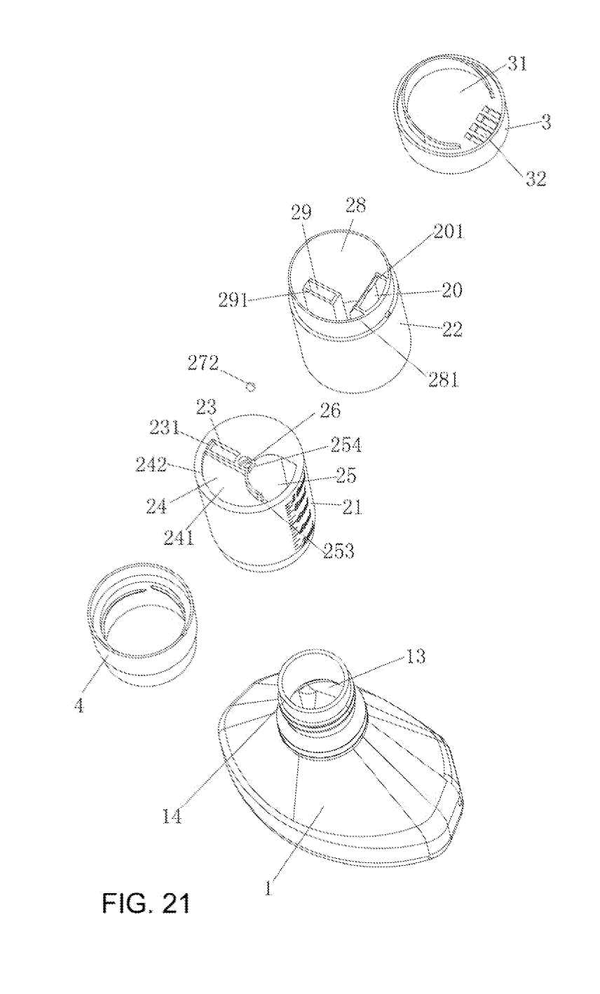

Referring to FIG. 18 to FIG. 20 of the drawings, the bottle arrangement according to this preferred embodiment comprises a bottle body and a measuring arrangement provided at a bottle opening of the bottle body.

The bottle body comprises a bottle wall 11 and a bottle base 12. A receiving cavity 13 is enclosed and defined by the bottle wall 11 and the bottle base 12.

The measuring arrangement comprises a measuring bucket 2 and a top cap 3. The measuring bucket 2 comprises a first measuring bucket 21 and a second measuring bucket 22 which are integrated with each other. The first measuring bucket 21 has a measuring-dispensing chamber 211 and a discharge channel 212 provided above the measuring-dispensing chamber 211. A chamber wall around the measuring-dispensing chamber 211 has an inlet opening 213 and a backflow opening 214. The first measuring bucket 21, which can be mounted on the bottle body 1 by screw connection, comprises a first base panel 215 and a ring-shaped first enclosing panel 216, a ring-shaped second enclosing panel 217 and a ring-shaped third enclosing panel 218 provided on the first base panel 215 in an inside to outside manner. The base panel 215 and the first enclosing panel 216 define a temporary storing chamber 23 which is communicated with the receiving chamber 13. The first enclosing panel 216, the second enclosing panel 217, and the first base panel 215 define a ring-shaped communicating channel 24 which is respectively communicated with the temporary storing chamber 23 and the inlet opening 213 of the measuring-dispensing chamber 211 at two ends thereof. The second enclosing panel 217, the first base panel 215, and the third enclosing panel 218 define a ring-shaped backflow channel 25 which has a communicating hole 219 provided in the first base panel 215. The backflow channel 25 has an end communicated with the receiving chamber 13 through the communicating hole 219 and another end communicated with the backflow opening 214 of the measuring-dispensing chamber 211. The backflow opening 214 and the inlet opening 213 of the measuring-dispensing chamber 211 are partitioned from each other, and in the gravity direction, a position of the inlet opening 213 is higher than a position of the backflow opening 214. The first base panel is constructed to be the chamber base of the temporary storing chamber. The second measuring bucket further has an inlet chamber 26 arranged in an up-down penetration manner which communicates the receiving chamber 13 to the temporary storing chamber 23. The inlet chamber 26 is defined by a chamber wall 261 which is provided at a position higher than a position of the first base panel 215.

The top cap 3 is detachably mounted on the measuring bucket 2.

When measuring and dispensing the fluid, the bottle body is overturned several times so that the fluid in the receiving chamber firstly flows into the temporary storing chamber 23 of the first measuring bucket, and then the fluid in the temporary storing chamber flows into the measuring-dispensing chamber 211 through the communicating channel 24, the fluid in the measuring-dispensing chamber 211 is finally discharged through the discharge channel 212. When the measuring-dispensing chamber 211 is full of the fluid, the fluid continually flowing into the measuring-dispensing chamber 211 is guided to flow back into the receiving chamber 13 through the backflow opening 214 and the backflow channel 25.

### Embodiment 7

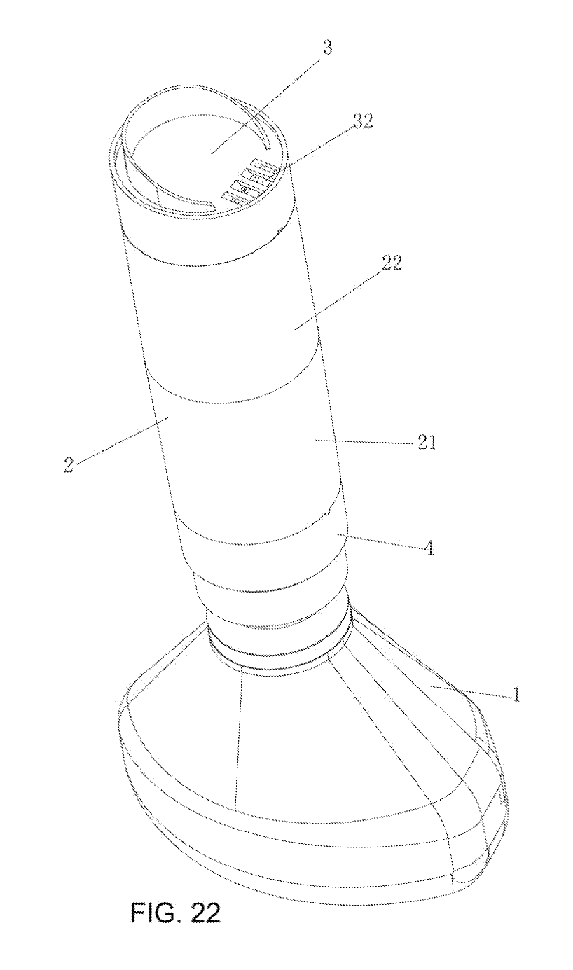

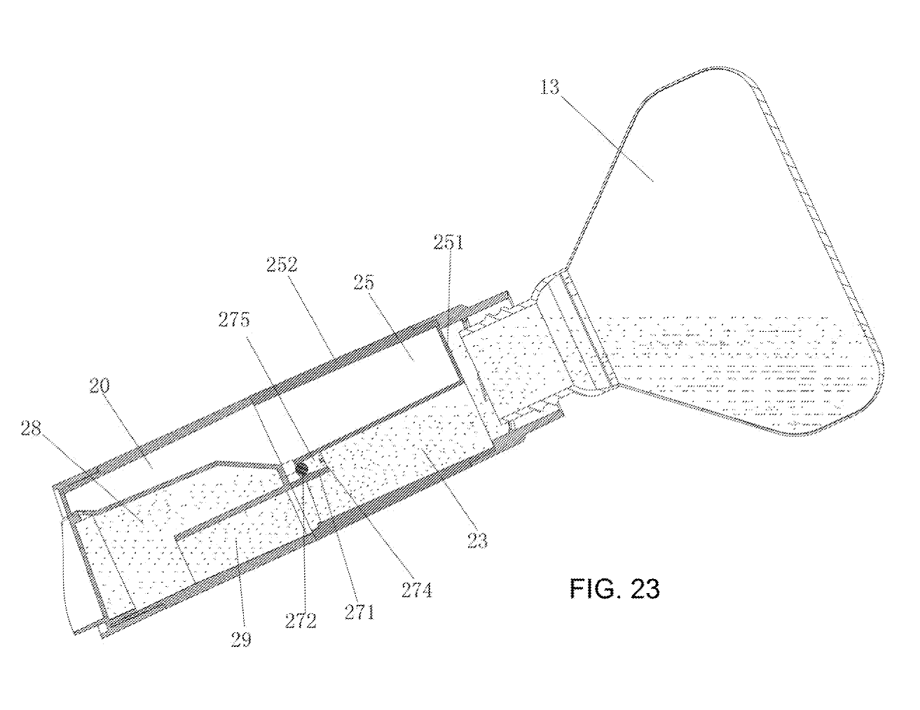

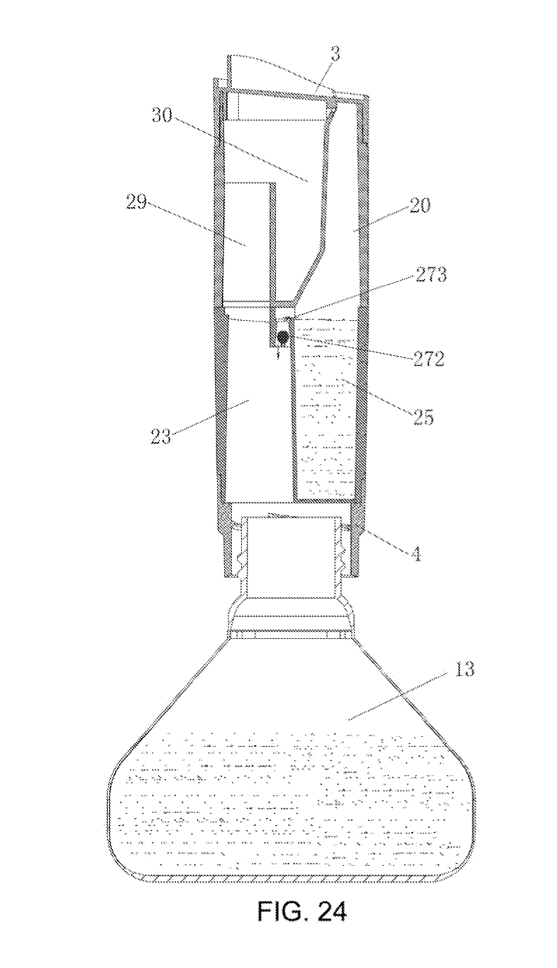

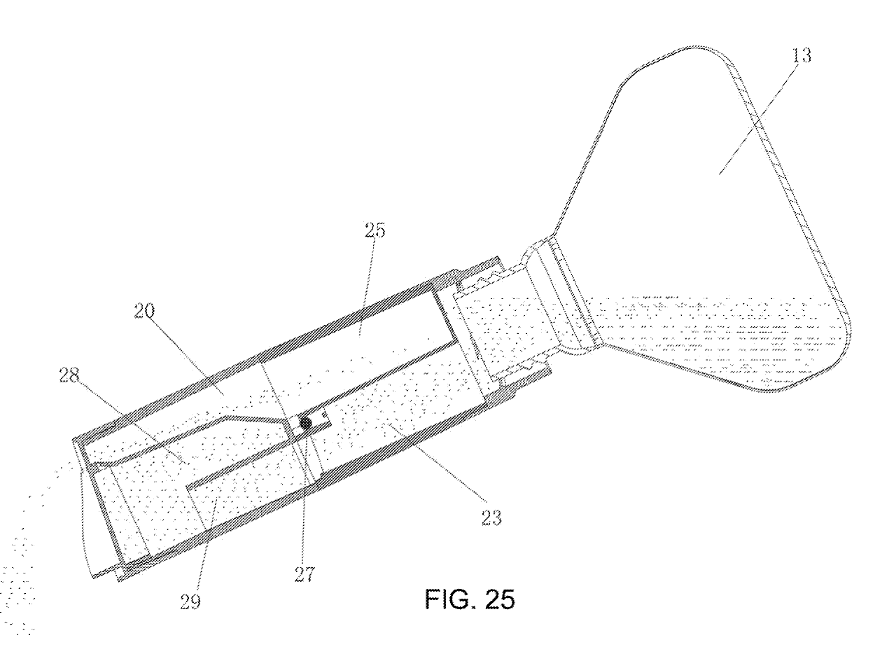

Referring to FIG. 22 to FIG. 25 of the drawings, a bottle arrangement according to this preferred embodiment comprises a bottle body 1, a measuring bucket 2 and a top cap 3.

The bottle body has a receiving chamber 13 which has a bottle base 12 at a bottom side thereof and a bottle opening 14 at a top side thereof.

The measuring bucket 2 comprises a first measuring bucket 21 and a second measuring bucket 22. The first measuring bucket 21 has a first inlet channel 23, a first lower compartment 24, and a second compartment 25. The first inlet channel 23, which is defined by an inlet chamber wall 231 having a ring-shaped cross section, is provided in an up-down penetration manner. The first lower compartment 24 has a first lower compartment base 241 which can be embodied as a slanted surface capable of guiding the fluid to flow under the influence of gravity, and a first lower compartment wall 242 having a ring-shaped cross section. The second compartment 25 has a second compartment base 251 and a second compartment wall 252 having an inlet opening 253 and a backflow opening 254. The inlet opening 253 is provided at a lower position of the second compartment base. A position of the inlet opening is not lower than a position of the backflow opening. Preferably, the position of the inlet opening is higher than the position of the backflow opening. A backflow channel 26, which communicates the backflow opening 254 to the receiving chamber 13, is provided with a one-way valve 27 controlling the open and close of the backflow channel. In a preferred embodiment, the one-way valve 27 comprises a valve body 271 and a valve core 272. The valve body 271 has a tapered valve chamber 271 having an inner diameter at a lower portion is smaller than an inner diameter at a higher portion. The valve core 272 is embodies as a ball. The valve chamber 275 defines a valve opening 273 at a minimized inner diameter thereof. An outer diameter of the valve core 272 is large than the inner diameter of the valve opening 273 but is smaller than the largest inner diameter of the valve chamber 271. A blocking member 274 is provided at the largest inner diameter of the valve chamber 275 for preventing the valve core to fall off. The positions of up and down herein are determined with respect to the gravity direction.

The second measuring bucket 22 has an upper compartment 28, a second inlet channel 29, and a discharge channel 20. The second upper compartment 28 has a second upper compartment wall 281 having a ring-shaped cross section and is arranged in an up-down penetration manner. The second inlet channel 29 is defined by a third compartment wall 291 having a ring-shaped cross section and is arranged in an up-down penetration manner. The discharge channel 20 is defined by a fourth compartment wall 201 having a ring-shaped cross section and is arranged in an up-down penetration manner.

The top cap 3 has a sealing portion 31 which can closed and seal the top side of the second upper wall, and a discharge opening 32 communicating the discharge channel to outside.

During an assembly process, a connecting ring 4 is coupled with the bottle opening 14 of the bottle body by screw connection. The first measuring bucket 21 is sealedly mounted to the connecting ring 4, the mounting method can be glue bonding connection, screw connection, form-fitting connection, plug/bush connection or other mounting method. The second measuring bucket 22 is then mounted to the first measuring bucket by the above mentioned methods. The top cap is finally capped on the second measuring bucket 22. After assembling, the first lower compartment 24 and the first upper compartment 28 form a first compartment 30. The first lower compartment base 241 is constructed to be a first compartment base of the first compartment 30, the first lower compartment wall and the first upper compartment wall are sealed and coupled with each other to form a first compartment wall of the first compartment. The discharge channel and the second compartment are sealed and coupled with each other. The first inlet channel 23 and the second inlet channel 29 are sealed and coupled with each other to form an inlet passage.

In an initial state, the fluid is stored in the receiving chamber 13 and the bottle body is in an upright state. When measuring and dispensing the fluid, the bottle arrangement is overturned for a first time so that the measuring bucket and the bottle body are in an upside-down state. During the overturning process, under the influence of gravity, the fluid in the receiving chamber 13 passes through the first inlet channel 23 and the second inlet channel 29 to flow into the first compartment 30, the valve core 272 closes the valve opening (i.e. the one-way valve is closed), so that the fluid in the receiving chamber cannot flow into the second compartment 25. And then, the bottle arrangement is overturned again so that the measuring bucket and the bottle body return to the upright state, during this overturning process, under the influence of gravity, the fluid in the first compartment flows into the second compartment 25 through the inlet opening, the valve core moves away from the valve opening (i.e. the one-way valve is opened) to communicate the backflow channel with the receiving chamber so that the fluid climbs over the backflow opening is guided to flow into the receiving chamber through the backflow channel. Finally, the bottle arrangement is overturned for a third time so that the measuring bucket is overturned to be in the upside-down state, during this process, the valve core closes the valve opening, so that the fluid in the second compartment is discharged through the discharge channel and the discharge opening, and the fluid in the receiving chamber refills the second compartment.

### Embodiment 8

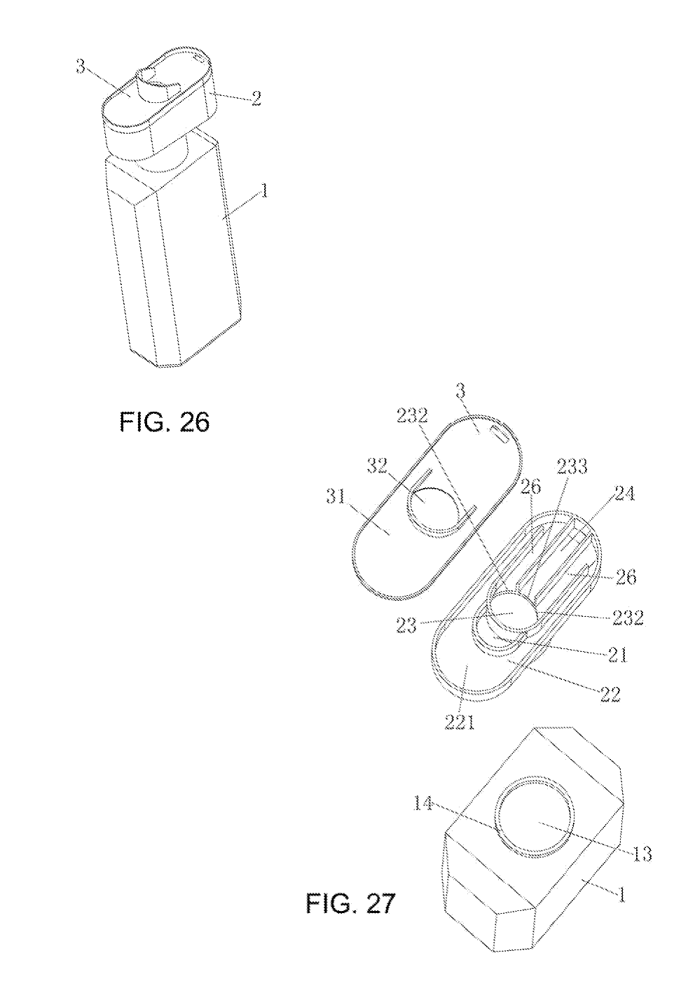

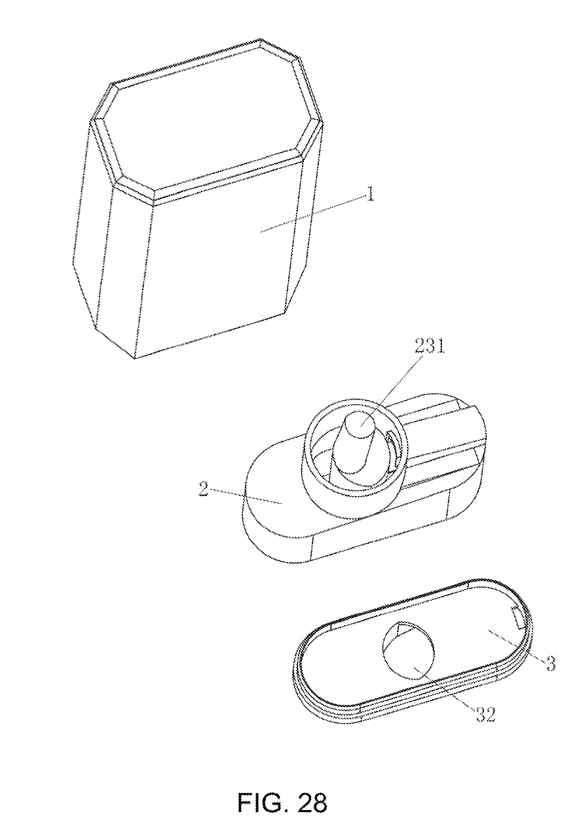

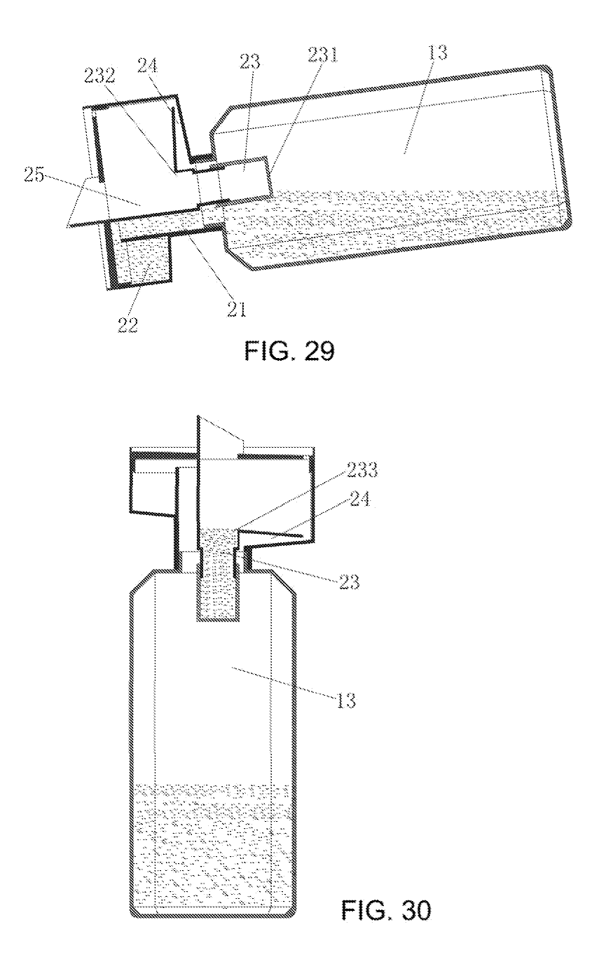

Referring to FIG. 26 to FIG. 32 of the drawings, a bottle arrangement according to this preferred embodiment comprises a bottle body 1, a measuring bucket 2 and a top cap 3. The bottle body has a receiving chamber 13 which has a bottle base 12 at a bottom side thereof and a bottle opening 14 at a top side thereof.

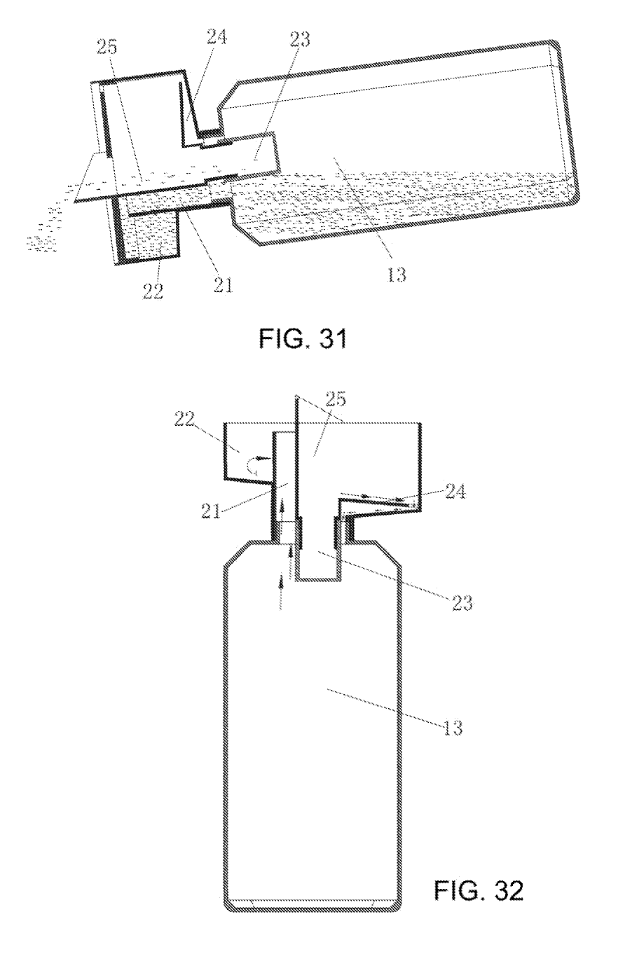

The measuring bucket 2 is detachably mounted at the bottle opening 14. The measuring bucket 2 has an inlet channel 21, a first compartment 22 having a first compartment base 221, a second compartment 23 having a second compartment base 231, a backflow channel 24, and a discharge channel 25. The inlet channel 21 communicates the receiving chamber 13 to the first compartment 22. The first compartment base 221 is embodies as a slanted surface which is capable of guiding the fluid to flow into the second compartment 23 under the influence of gravity. The second compartment 23 has two inlet opening 232 and an inlet opening 233. The backflow channel 24 is communicated with inlet opening 233 and the receiving chamber 13. The discharge channel 25 is communicated with the second compartment 23. The top cap 3 has a sealing portion 31 for closing and sealing the top opening of the second compartment, and a flow guiding opening 32 communicated with the discharge channel. The backflow channel 24 and the inlet channel 21 are respectively provided at two sides of the second compartment 23. When the measuring bucket is in an upside-down state, the integral backflow channel 24 is provided above the fluid in the receiving chamber 13, so that the fluid in the receiving chamber 13 cannot flow into the second compartment 23. The measuring bucket can further have a communicating channel 26 for communicating the first compartment 22 to the inlet opening 232 of the second compartment. When measuring and dispensing the fluid, a flow route of the fluid is shown by arrows in FIG. 32 of the drawings. In addition, the compartment base of the second compartment is movable so that a volume of the second compartment can be changed.

An overturning device for measuring and dispensing fluid comprises a measuring bucket provided above a bottle body, the measuring bucket has a measuring-dispensing chamber, discharge channel, an inlet channel for guiding the fluid in the bottle body to flow into the measuring-dispensing chamber, and a backflow channel for guiding the fluid in the measuring-dispensing chamber to flow back into the bottle body or the inlet channel. The measuring-dispensing chamber has a chamber base at a bottom side thereof and a backflow determining a volume of the measuring-dispensing chamber. The inlet channel is communicated with the measuring-dispensing chamber. The discharge channel communicates the measuring-dispensing chamber to outside. The backflow channel is communicated with the backflow opening. The backflow channel, the inlet channel are partitioned from the discharge channel, so that during the filling, back flowing, or the discharging process, the fluid will be not easy to mistakenly flow into other channels. The discharge channel is provided above the measuring-dispensing chamber. The storing chamber is used to storing the fluid. The measuring-dispensing chamber, which is used to precisely measure and dispense the fluid, has a predetermined volume which has relation with a position of the backflow opening. The inlet channel defines a route of the fluid flowing from the receiving chamber to the measuring-dispensing chamber. The backflow channel defines a route of the fluid flowing from the measuring-dispensing chamber to the receiving chamber. The discharge channel is used to communicate the measuring-dispensing chamber to outside. The inlet channel communicating the measuring-dispensing chamber to outside can be embodied as any channel including the inlet channel, inlet chamber, temporary storing chamber, and communicating channel in the above mentioned preferred embodiments.

The measuring bucket has a first state in which the fluid in the first compartment (temporary storing chamber) is capable of flowing into the second compartment, and a second state in which the fluid in the first compartment cannot flow into the second compartment. When in the first state, the measuring bucket is in an upright position which can be in a direction of vertically facing upward, levelly facing upward or inclinedly facing upward. When in the second state, the measuring bucket is in an upside-down state in which the measuring bucket can be inclinedly facing downward. In order to facilitating the fluid in the first compartment to flow into the second compartment, the first compartment base can have a guiding surface which can be embodied as a single guiding surface or a surface formed by a plurality of adjoining slanted surfaces, or other surface which is capable of guiding the flow of the fluid.

In the measuring bucket, a one-way valve is provided in the backflow channel in order to prevent the fluid in the receiving cavity from flowing into the second compartment (measuring-dispensing chamber) in the first state. Alternatively, in the first state, the backflow opening and the backflow channel are provided above the fluid in the receiving chamber.

In the measuring bucket, the first compartment and the respectively second compartment both have a closed compartment base and a top opening. In other words, both the first compartment and the respectively second compartment are defined by a compartment base and a compartment wall having a ring-shaped cross section. The cross section can be constructed to be in annular ring shape, triangle ring shape, oval ring shape, runway ring shape, square ring shape, other regular or irregular ring shape. The ring shape can be formed as a closed ring shape or non-closed ring shape. The compartment wall also can be formed in other shapes. The top opening of the first compartment can be closed and sealed by the top cap. The inlet channel, which is arranged in an up-down penetration manner, can be deemed to be defined by the compartment wall having a ring-shaped cross section. The backflow channel, which is defined by the chamber base and the chamber wall, has a predetermined volume and provides functions of both backflow and temporary storage for the fluid. The backflow channel also can be constructed to be a penetration structure which does not provide a temporary storage effect. The discharge channel can be formed in a penetration structure. The first compartment can be directly communicated with the inlet opening of the second compartment. Of course, the first compartment can be communicated with the inlet opening of the second compartment through the communicating channel. The compartment bases and the compartment walls of the measuring bucket can be individually provided and forms an one piece structure by means of the measuring bucket body. The compartment bases and the compartment walls also can be shared or partially shared. For example, the first compartment and the second compartment share part of the compartment walls. Because the first compartment has a first compartment base, a temporary storage of the fluid can be provided. Because the second compartment has a second compartment base, a precise measure and dispense of the fluid can be achieved.

In the measuring bucket, the first compartment base of the first compartment can be provided above the second compartment base of the second compartment. The first compartment can be totally or partially provided above the second compartment. The inlet opening can be provided above the backflow opening.

In the measuring bucket, the backflow channel can be directly communicated with the receiving chamber of the bottle body, so that the overflowing fluid from the backflow opening of the second compartment will directly flow back into the receiving chamber. The backflow channel also can be directly communicated with the first compartment (temporary storing chamber), so that the overflowing fluid from the backflow opening will directly flow back into the first compartment.

The overturning device for measuring and dispensing fluid can be cooperated and used together with bottle bodies of varied specifications, or alternatively mounted with the bottle body to form a bottle arrangement.

In the bottle arrangement, the measuring-dispensing chamber, the receiving chamber and other channels can be formed by means of a plurality of partition panels in the bottle body, or alternatively individually provided in the measuring bucket. The measuring bucket is cooperated with the bottle body to achieve the measure and dispense of the fluid. The measuring bucket can be a single component or assembled by two or more components.

One skilled in the art will understand that the embodiment of the present invention as shown in the drawings and described above is exemplary only and not intended to be limiting.

It will thus be seen that the objects of the present invention have been fully and effectively accomplished. It embodiments have been shown and described for the purposes of illustrating the functional and structural principles of the present invention and is subject to change without departure from such principles. Therefore, this invention includes all modifications encompassed within the spirit and scope of the following claims.

1. An overturning device for measuring and dispensing fluid, comprising a measuring bucket for using with a bottle body, wherein said measuring bucket has a backflow channel, a first compartment having a first compartment base, and a second compartment having a second compartment base, wherein said second compartment has an inlet opening for inlet of the fluid, and a backflow opening for backflow of the fluid, wherein said first compartment is communicated with said inlet opening, wherein said backflow opening is communicated with said backflow channel, wherein said measuring bucket has a first state in which the fluid in said first compartment is capable of flowing into said second compartment under the influence of gravity, and a second state in which the fluid in said first compartment is not capable of flowing into said second compartment, wherein in said first state, the fluid overflowing from said backflow opening of said second compartment flows into said backflow channel, wherein a volume of said first compartment is larger than or equal to a volume of said second compartment, wherein said backflow opening serves to calibrate the fluid volume of said second compartment.

2. The overturning device for measuring and dispensing fluid according to claim 1, wherein said first compartment has a guiding channel guiding the fluid in said first compartment to flow into said second compartment, wherein said guiding channel is inclinedly arranged to define a high location at a relatively higher position and a low location at a relatively lower position, wherein said inlet opening is provided at said low location.

3. The overturning device for measuring and dispensing fluid according to claim 1, wherein said measuring bucket further has a discharge channel for communicating the bottle body to said first compartment, and an inlet channel provided above said second compartment and is communicated with said second compartment.

4. The overturning device for measuring and dispensing fluid according to claim 3, wherein said inlet channel and said backflow channel are respectively provided at two sides of said second compartment.

5. The overturning device for measuring and dispensing fluid according to claim 3, wherein said measuring bucket comprises a first measuring bucket and a second measuring bucket which are integrated with each other, wherein said inlet channel has a first inlet channel and a second inlet channel which are sealedly open butt joined with each other, wherein said first compartment has a first lower compartment and a first upper compartment which are sealedly open butt joined with each other, wherein said first lower compartment, said first inlet channel, said backflow channel, and said second compartment are provided in said first measuring bucket, wherein said first upper compartment, said first inlet channel, and said discharge channel are provided in said second measuring bucket, wherein said discharge channel is sealedly open butt joined with said second compartment.

6. The overturning device for measuring and dispensing fluid according to claim 1, wherein said backflow channel is provided with a one-way valve for preventing the fluid in the bottle body from flowing into said second compartment in said first state.

7. The overturning device for measuring and dispensing fluid according to claim 1, wherein said backflow channel has a first backflow chamber having a base wall and an opening communicated with said first compartment.

8. The overturning device for measuring and dispensing fluid according to claim 3, further comprising a first top cap capped on said measuring bucket, wherein said first top cap has a sealing portion for covering said inlet channel and said first compartment, and a discharge opening communicated with said discharge channel.

9. A bottle arrangement, comprising: a bottle body defining a receiving chamber having a bottle opening and a bottle base, and an overturning device for measuring and dispensing fluid in claim 1, wherein said measuring bucket is mounted at said bottle opening, wherein said first compartment is communicated with said receiving chamber, wherein said backflow channel is communicated with said receiving chamber.

10. A bottle arrangement, comprising a bottle body, a top cap, a first partition panel, a second partition panel, and a third partition panel, wherein said bottle body comprises a bottle base and a bottle wall, wherein said top cap is capped on a top side of said bottle wall, wherein said first partition panel and said second partition panel, which are extended upward from said bottle base, are fastened with said bottle wall, wherein said third partition panel is extended downward from a top portion of said bottle wall, wherein said first partition panel, said bottle base, and said bottle wall are enclosed to define a receiving chamber, wherein said second partition panel, said bottle base, and said bottle wall are enclosed to define a measuring-dispensing chamber, wherein said first partition panel, said third partition panel, and said bottle wall are enclosed to define a temporary storing chamber and a communicating channel, wherein said third partition panel and said bottle wall are enclosed to define a discharge channel, wherein said communicating channel communicates said temporary storing chamber to said measuring-dispensing chamber, wherein said measuring-dispensing chamber has a backflow opening, wherein said first backflow chamber communicates said backflow opening to said temporary storing chamber, so that the fluid overflowing from backflow opening of said measuring-dispensing chamber is capable of flowing into said first backflow chamber.

11. An overturning device for measuring and dispensing fluid, comprising a measuring bucket for mounting above a bottle body, wherein said measuring bucket has a measuring-dispensing chamber, a discharge channel, an inlet channel for guiding the fluid in the bottle body to flow into said measuring-dispensing chamber, and a backflow channel for guiding the fluid in said measuring-dispensing chamber to flow back into the bottle body, wherein said measuring-dispensing chamber has a base wall at a bottom side thereof, and a backflow opening for calibrating a volume of said measuring-dispensing chamber, wherein said inlet channel is communicated with said measuring-dispensing chamber, wherein said discharge channel communicate said measuring-dispensing chamber to outside, wherein said backflow channel is communicated with said backflow opening, wherein said backflow channel and said inlet channel are both partitioned from said discharge channel, wherein said discharge channel is provided above said measuring-dispensing chamber.

12. The bottle arrangement according to claim 9, wherein said first compartment has a guiding channel guiding the fluid in said first compartment to flow into said second compartment, wherein said guiding channel is inclinedly arranged to define a high location at a relatively higher position and a low location at a relatively lower position, wherein said inlet opening is provided at said low location.

13. The bottle arrangement according to claim 9, wherein said measuring bucket further has a discharge channel for communicating the bottle body to said first compartment, and an inlet channel provided above said second compartment and is communicated with said second compartment.

14. The bottle arrangement according to claim 13, wherein said inlet channel and said backflow channel are respectively provided at two sides of said second compartment.

15. The bottle arrangement according to claim 13, wherein said measuring bucket comprises a first measuring bucket and a second measuring bucket which are integrated with each other, wherein said inlet channel has a first inlet channel and a second inlet channel which are sealedly open butt joined with each other, wherein said first compartment has a first lower compartment and a first upper compartment which are sealedly open butt joined with each other, wherein said first lower compartment, said first inlet channel, said backflow channel, and said second compartment are provided in said first measuring bucket, wherein said first upper compartment, said first inlet channel, and said discharge channel are provided in said second measuring bucket, wherein said discharge channel is sealedly open butt joined with said second compartment.

16. The bottle arrangement according to claim 9, wherein said backflow channel is provided with a one-way valve for preventing the fluid in the bottle body from flowing into said second compartment in said first state.

17. The bottle arrangement according to claim 9, wherein said backflow channel has a first backflow chamber having a base wall and an opening communicated with said first compartment.

18. The bottle arrangement according to claim 13, further comprising a first top cap capped on said measuring bucket, wherein said first top cap has a sealing portion for covering said inlet channel and said first compartment, and a discharge opening communicated with said discharge channel.
